(19) United States
(12) Patent Application Publication
(10) Pub. No.: US 2013/0095909 A1
(43) Pub. Date: Apr. 18, 2013

(54) METHOD FOR PLAYING A SPORTS GAME, AND A GAMING DEVICE

(71) Applicant: Robert Louis O'Dea, Los Altos Hills, CA (US)

(72) Inventor: Robert Louis O'Dea, Los Altos Hills, CA (US)

(21) Appl. No.: 13/273,110

(22) Filed: Oct. 13, 2011

(51) Int. Cl. A63F 13/10; A63F 13/12; A63F 9/24

(52) U.S. Cl. 463/25; 463/43; 463/42

(57) ABSTRACT

A method of playing a sports game comprises displaying on a computer monitor a representation of a field upon which the sports game is played, as the sports game is played. The field displayed has a plurality of sections. The odds of the sports game being played in each of the plurality of sections is displayed, as the sports game plays. The odds in each of the plurality of sections, as the sports game is played is changed. Wagers can be placed by players for the sports game to occur in each of the sections, with payout occurring when play of the sports game reaches one of the sections.

### TECHNICAL FIELD

The present invention relates to a computer game for playing a sports game and more particularly, wherein the sports game displayed on a monitor is representative of an actual sports game being played, and wherein players can place wagers regarding the expected subsequent events of the game.

### BACKGROUND OF THE INVENTION

Sports games are widely played and appreciated by all. Sports games, both team, as well as individual sports games, span the globe geographically and culturally. However, heretofore sports games have been mostly enjoyed only as a spectator sport.

Computer simulation sports games are also well known in the art. In computer simulation sport games, a player has a team or individual which represents the player, and the team or individual is played against an opponent team or individual. However, in this type of game playing, the team assembled and the sports game played is generated by the computer and bears no relationship to any sports game played in reality.

Heretofore, one computer sports game that is played that has a relationship to reality is the so-called “Fantasy Football”. In Fantasy Football, a player selects computer based virtual players to create a virtual team and play against other virtual teams. These virtual players, however, may not be from the same team. In fact, most of the time they are not; hence the team is a virtual team. The winner of the competition between virtual teams is decided by the performance of the corresponding reality players, whose statistics during the actual play in the past game determines the virtual player's performance. The actual performance of the reality players, from the past game is then tallied to form the performance of the virtual team, as they are pitted against other virtual teams.

There are several disadvantages of Fantasy Football. First, the “winner” of the virtual teams is not determinable until a real game is played and the statistics of individual reality players are known. Second, each virtual team bears no relationship to any known reality team—hence the name of “Fantasy” football. As a result, feedback on the performance of one's virtual team is not known until the reality games are played and the statistics of all the reality players are know. Finally, one can't “cheer” for one's team, since that team is a “virtual team”.

Hence, there is a need to permit players to participate in the playing of a reality based sports games with more rapid feedback, and enjoyment.

### SUMMARY OF THE INVENTION

Accordingly, in the present invention, a method for participating in playing a sports game is disclosed. A representation of the field upon which the real sports game is played is displayed with the field having a plurality of sections. The odds of the sports game being played in each of the plurality of sections is displayed as the sports game is played in reality. Finally, the odds in each of the plurality of sections, as the sports game is played in reality can be dynamically changed.

### BRIEF DESCRIPTION OF THE DRAWINGS

FIG. 1 is a display of a field for playing American style football, in accordance with the method of the present invention.

FIG. 2 is a display of a field for playing Australian style football, in accordance with the method of the present invention.

FIG. 3 is a display of a field for playing baseball, in accordance with the method of the present invention.

FIG. 4 is a display of a field for playing basketball, in accordance with the method of the present invention.

FIG. 5 is a display of a field for playing cricket, in accordance with the method of the present invention.

FIG. 6 is a display of a field for playing ice hockey, in accordance with the method of the present invention.

FIG. 7 is a display of a field for playing International style football, or soccer, in accordance with the method of the present invention.

FIG. 8 is a display of a field for playing tennis, in accordance with the method of the present invention.

FIGS. 9(a-i) are displays of a field for playing International style football, or soccer, as the play proceeds in the corresponding reality sports game, in accordance with the method of the present invention.

FIG. 10 is a display of a field for playing American style football in accordance with another method of the present invention, in a social setting.

FIG. 11 is a schematic drawing of one embodiment for carrying out the method of the present invention showing a computer with programming code of the present invention connected to an interconnected network of computers (“Internet”) and through the Internet to a server.

FIG. 12 is a schematic diagram of one embodiment of a gaming apparatus of the present invention.

### DETAILED DESCRIPTION OF THE PREFERRED EMBODIMENT

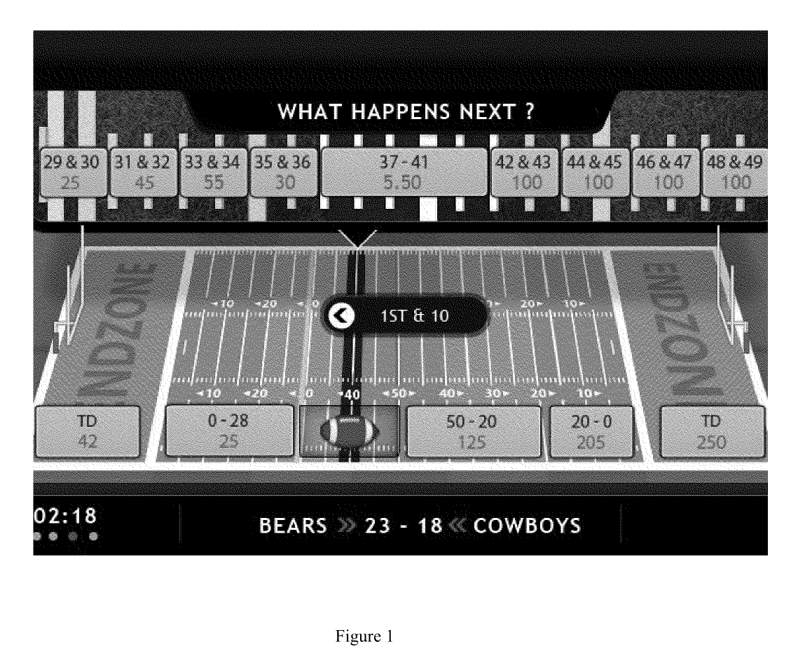

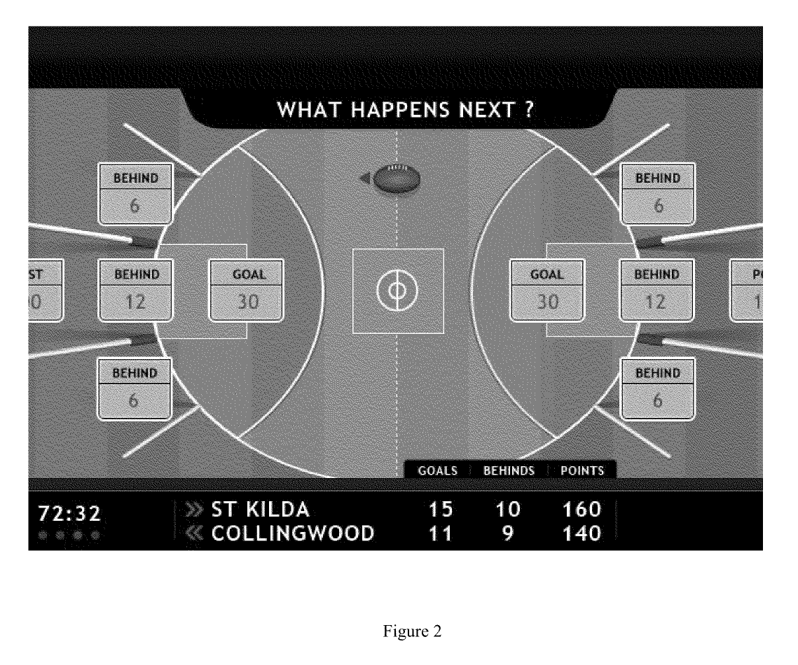

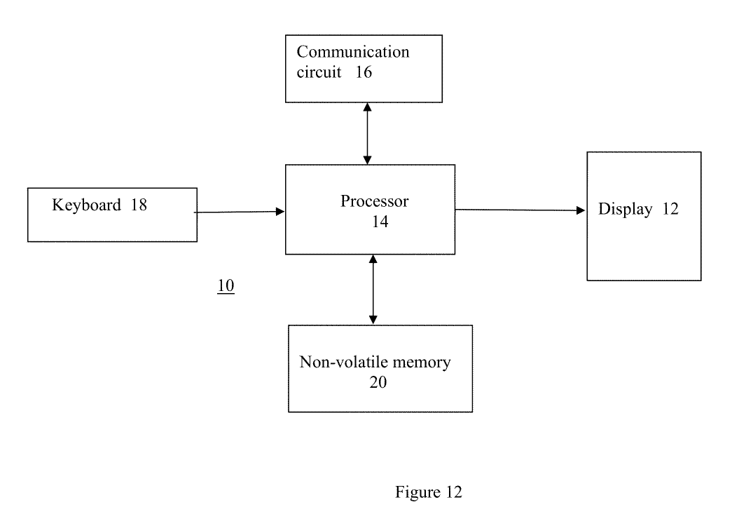

Referring to FIG. 1, there is shown a display of a field upon which the game of American football is played, to which the method of the present invention is applicable. The display shown in FIG. 1 is typically displayed on a computer monitor 12 of a computer system 10 (shown in FIG. 12). The display shown in FIG. 1 shows the sports game of American football being played between two actual teams of Bears and Cowboys. Further, the ball is shown on the forty (40) yard line with the play advancing from right to left. This representation is of the actual progress of the game being played between the Bears and the Cowboys. Thus, as the actual game between the Bears and the Cowboys is played, the display shown in FIG. 1 would be updated.

Displayed on the display 12 are different sections dividing the playing field. Thus, for example, on the playing field shown in FIG. 1, there are sections labeled (from left to right on the lower portion of the field): “TD”; “0-28”; “50-20”; “20-0” and “TD” with associate numbers of “42”; “25”; “125”; “205” and “250” for each of those sections.

Other sections are also shown at the top of the field. At the start of the game, a player may place wagers in one or more sections expecting where the ball would be at the end of the play. Within each section is a number indicating the return of a wager should the play result in the ball being in any of those sections. Thus, for example, should the team with the ball advance to the “20” yard line; then the ball would be in the section of “0-28” and if a one unit wager had been placed for the ball to be in that section, then the return for that wager would be 25 units. Similarly, if the team having possession of the ball advances the ball to the extreme left to achieve a touchdown or TD, the return on a one unit wager would be 42 units. Other sections are also displayed for the field. Thus, if the team having possession were to advance the ball to the 35 yard line, then players having wagered in the sections labeled “35 & 36” would be the winner, with a return of 30 units for each unit wagered. Once play has entered a section and settlement of the wager occurs, play resumes, with the potential payout from the sections being different from previous payout, since the play would commence from that starting point. The play continues in sync with the reality game played between the Bears and the Cowboys. A detailed example of the method of the present invention played with International style football, or soccer, will be discussed hereinafter.

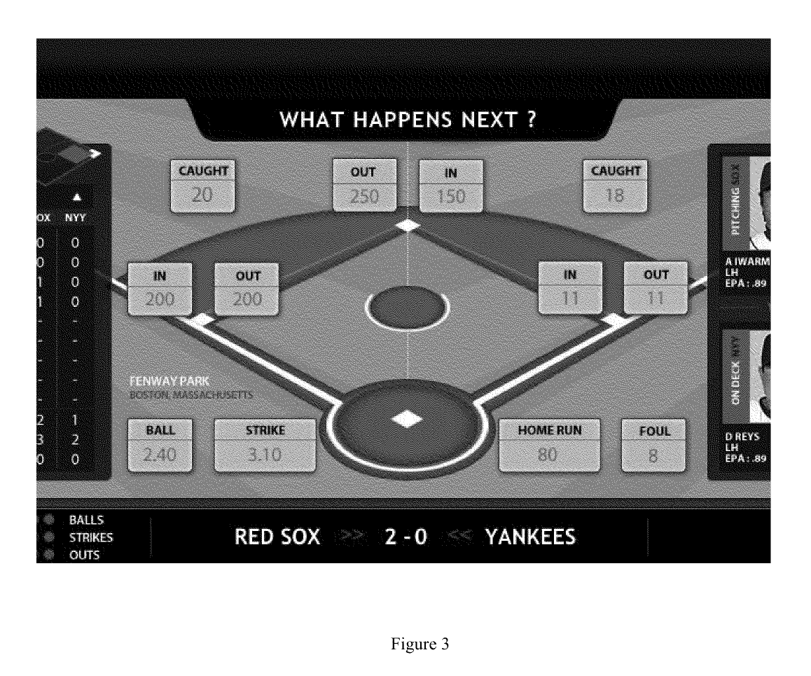

Referring to FIG. 2 there is shown a display of a field for playing Australian style football. Similar to the explanation for the method of the present invention applied to the American style football, as discussed and shown in FIG. 1, the field shown in FIG. 2 is divided into a plurality of sections, such as “Goal”, “Behind”, with each of the sections having an associated number representing the payout should a wager have been placed for that section and play of the corresponding real sports game entered that section. Similar to the manner of play discussed for American style football, a player can place wagers in one or more sections of the field shown in FIG. 2. Then as the corresponding real game is played, between St. Kilda and Collingwood, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

Referring to FIG. 3 there is shown a display of a field for playing baseball. Similar to the explanation for the method of the present invention applied to the American style football, as discussed and shown in FIG. 1, and other sport games discussed heretofore, the field shown in FIG. 3 is divided into a plurality of sections, such as “ball”, “strike”, “home run”, “foul” “in”/“out” for each base, and “caught” for the left/right sections of the field. Further, each of the sections has an associated number representing the payout should a wager have been placed for that section and play of the corresponding real sports game entered that section, or that result occurred. Similar to the manner of play discussed for American style football and other games discussed heretofore, a player can place wagers in one or more sections of the field shown in FIG. 3. Then as the corresponding real game is played, between the Yankees and the Red Sox, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

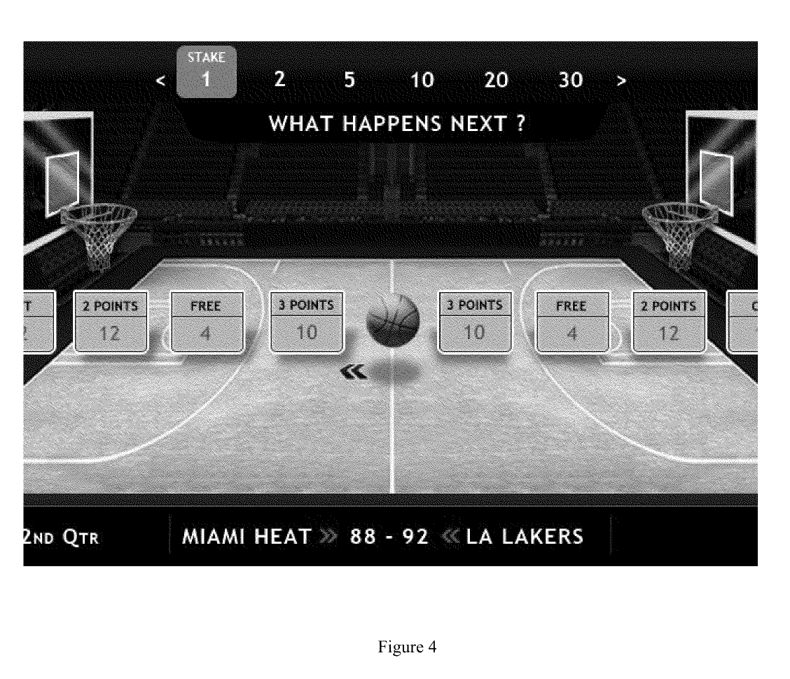

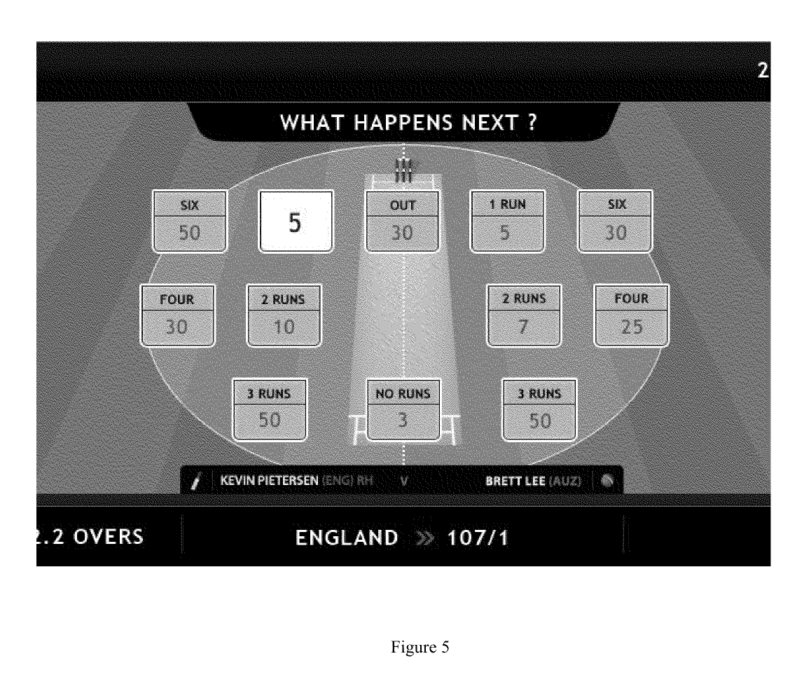

Referring to FIG. 4 there is shown a display of a field for playing basketball. Similar to the explanation for the method of the present invention applied to the American style football, as discussed and shown in FIG. 1, and other sport games discussed heretofore, the field shown in FIG. 4 is divided into a plurality of sections, such as “3 points”, “free”, “2 points” for each side of the basket court. Further, each of the sections has an associated number representing the payout should a wager have been placed for that section and play of the corresponding real sports game entered that section, or that result occurred. Similar to the manner of play discussed for American style football and other games discussed heretofore, a player can place wagers in one or more sections of the field shown in FIG. 4. Then as the corresponding real game is played, between Miami Heat and the LA Lakers, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

Referring to FIG. 5 there is shown a display of a field for playing cricket. Similar to the explanation for the method of the present invention applied to the American style football, as discussed and shown in FIG. 1, and other sport games discussed heretofore, the field shown in FIG. 5 is divided into a plurality of sections, such as “1 run”, “2 runs”, “3 runs”, “four” and “six” for each side of the field, and “no runs” and “out”. Further, each of the sections has an associated number representing the payout should a wager have been placed for that section and play of the corresponding real sports game entered that section, or that result occurred. Similar to the manner of play discussed for American style football and other games discussed heretofore, a player can place wagers in one or more sections of the field shown in FIG. 5. Then as the corresponding real game is played, between England and Australia, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

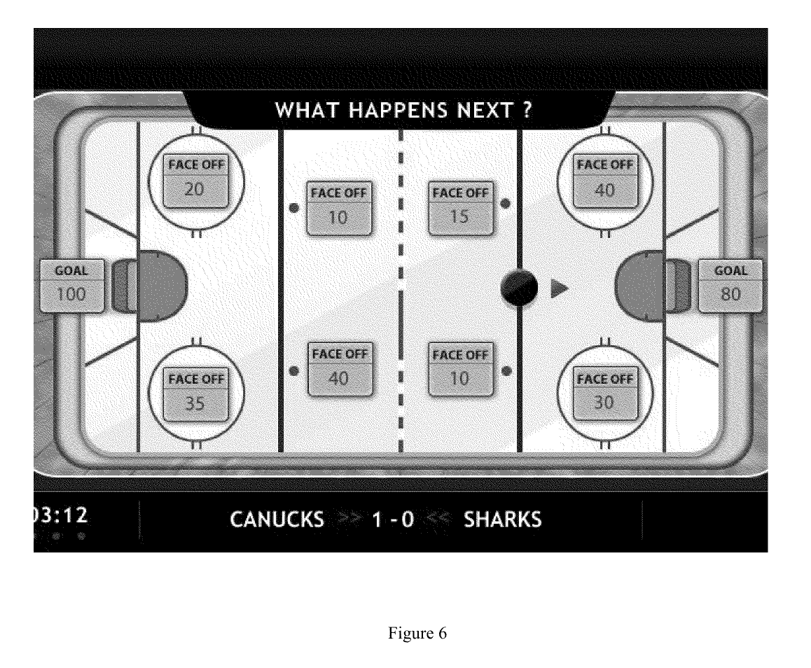

Referring to FIG. 6 there is shown a display of a field for playing ice hockey. Similar to the explanation for the method of the present invention applied to the American style football, as discussed and shown in FIG. 1, and other sport games discussed heretofore, the field shown in FIG. 6 is divided into a plurality of sections, such as various “face offs” and “goal” for each side of the field. Further, each of the sections has an associated number representing the payout should a wager have been placed for that section and play of the corresponding real sports game entered that section, or that result occurred. Similar to the manner of play discussed for American style football and other games discussed heretofore, a player can place wagers in one or more sections of the field shown in FIG. 6. Then as the corresponding real game is played, between the Canucks and the Sharks, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

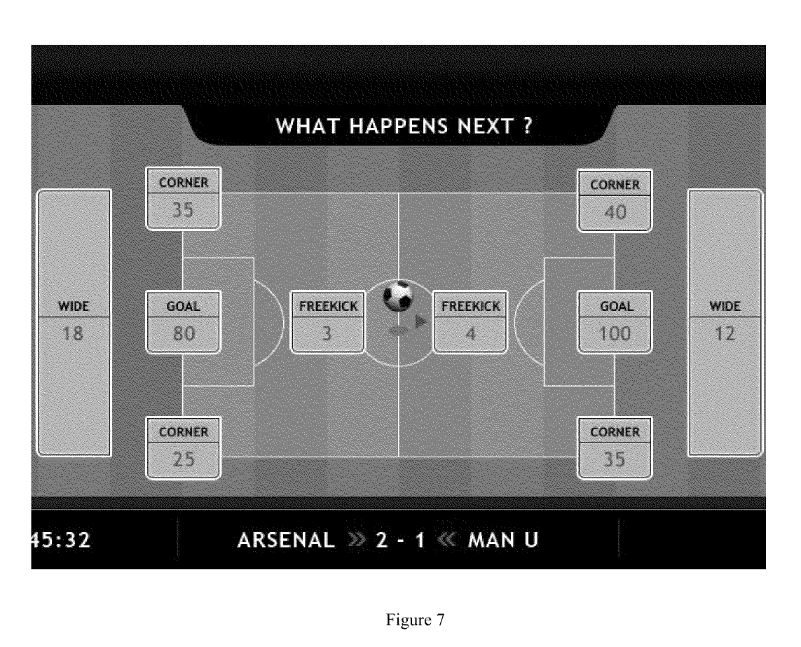

Referring to FIG. 7 there is shown a display of a field for playing International football or soccer. Similar to the explanation for the method of the present invention applied to the American style football, as discussed and shown in FIG. 1, and other sport games discussed heretofore, the field shown in FIG. 7 is divided into a plurality of sections, such as “free kick”, “goal”, two “corner” and “wide” for each side of the field. Further, each of the sections has an associated number representing the payout should a wager have been placed for that section and play of the corresponding real sports game entered that section, or that result occurred. Similar to the manner of play discussed for American style football and other games discussed heretofore, a player can place wagers in one or more sections of the field shown in FIG. 7. Then as the corresponding real game is played, between Manchester Union and Arsenal, causing the play to result in one of the sections of the field, then the pay-off or settlement of the wagers occurs. Then play resumes, and players can again place wagers on one or more of the sections. Once play has entered a section and settlement of the wager occurs, play resumes, with the payout from the sections being potentially different from previous payout, since the play would commence from that event.

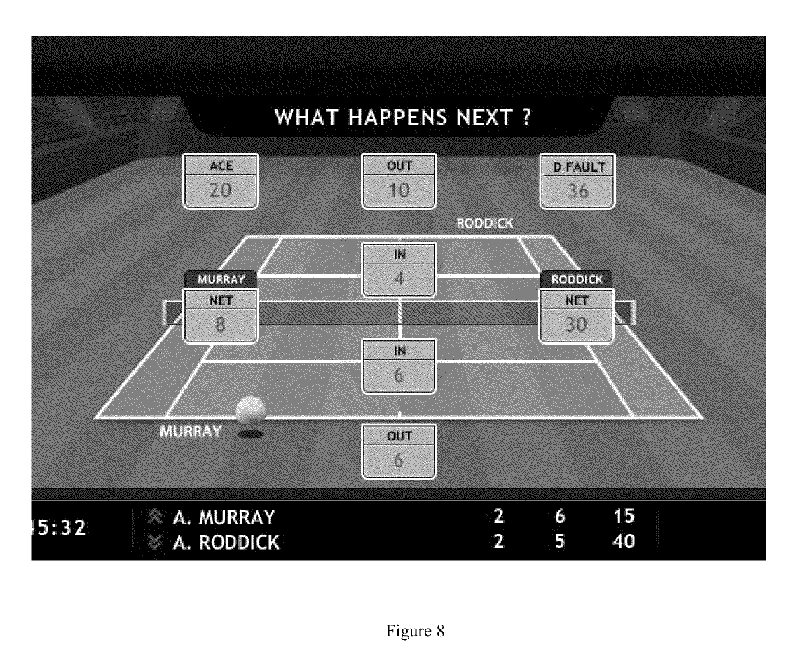

Referring to FIG. 8 there is shown a display of a field for playing tennis. Similar to the explanation for the method of the present invention applied to the American style football, as discussed and shown in FIG. 1, and other sport games discussed heretofore, the field shown in FIG. 8 is divided into a plurality of sections, such as “ace”, “out”, “in”, “double fault” “net” and “in”/“out” for each side of the field. Further, each of the sections has an associated number representing the payout should a wager have been placed for that section and play of the corresponding real sports game resulted in the tennis point having being won or lost with the last bounce of the ball having entered that section. Similar to the manner of play discussed for American style football and other games discussed heretofore, a player can place wagers in one or more sections of the field shown in FIG. 8. Then as the corresponding real game is played, between Andy Murray and Andy Roddick, resulting in the tennis point having being won or lost with the last bounce of the ball having being in one of the sections of the field, then the pay-off or settlement of the wagers occurs. Then play resumes, and players can again place wagers on one or more of the sections. Once the tennis point has been won or lost with the last bounce of the ball having entered a section, settlement of the wager occurs, play resumes, with the payout from the sections being potentially different from previous payout, since the play would commence from that event.

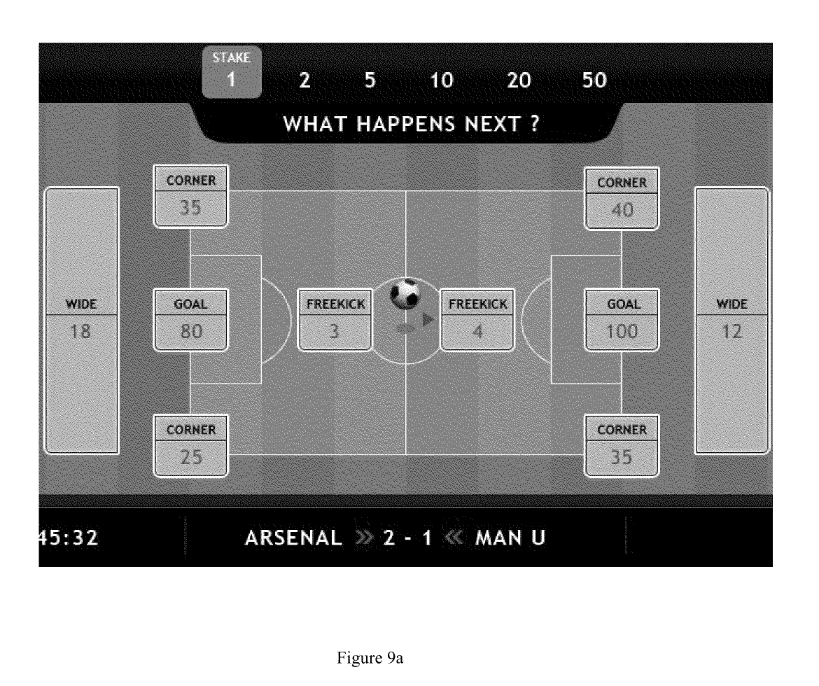

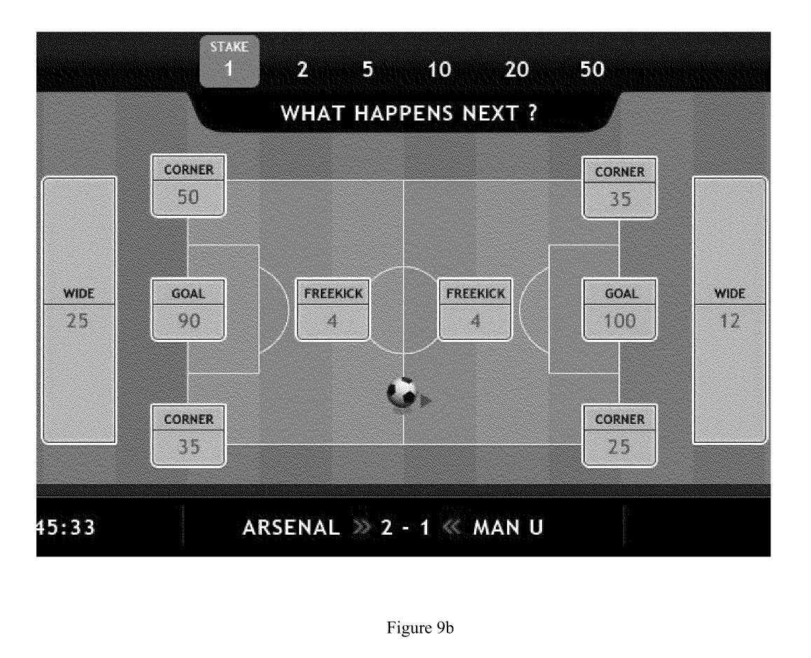

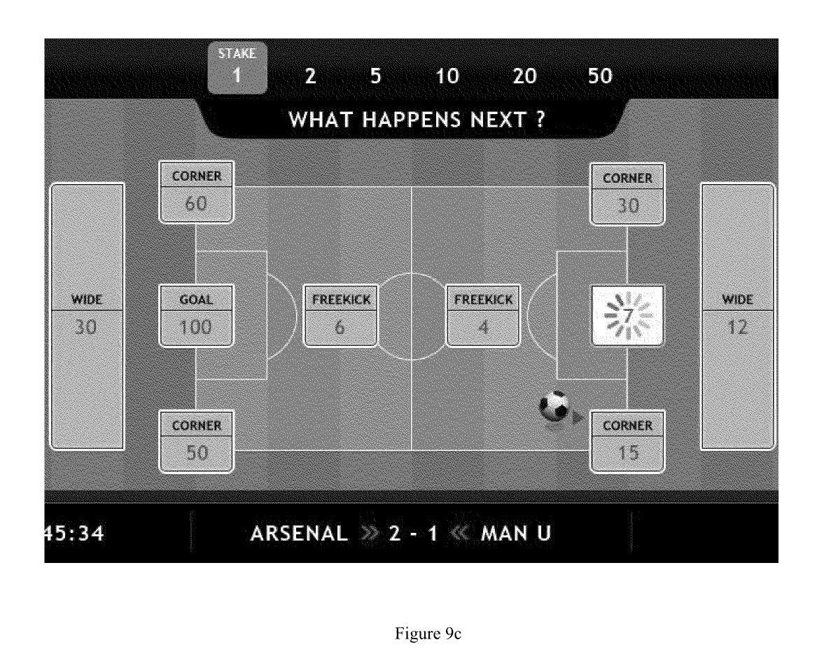

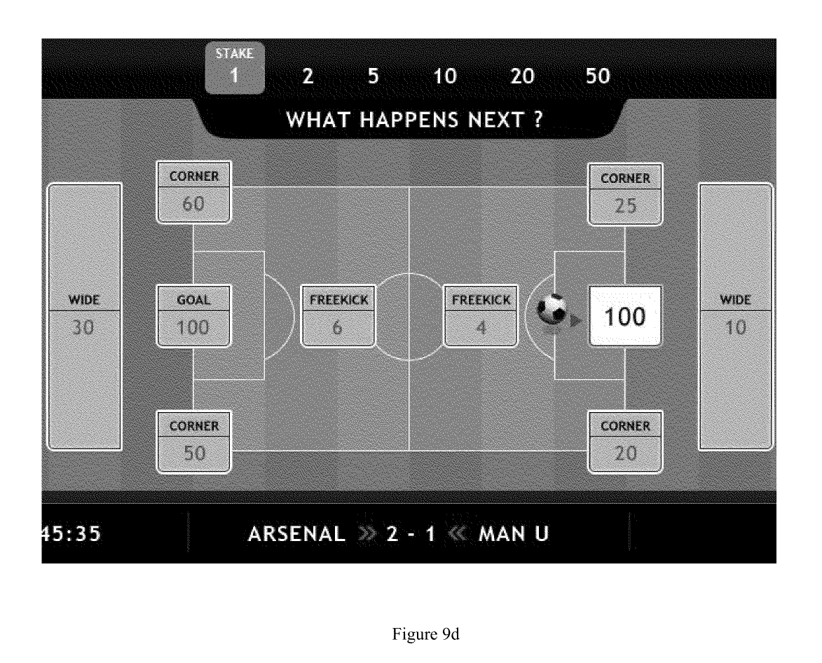

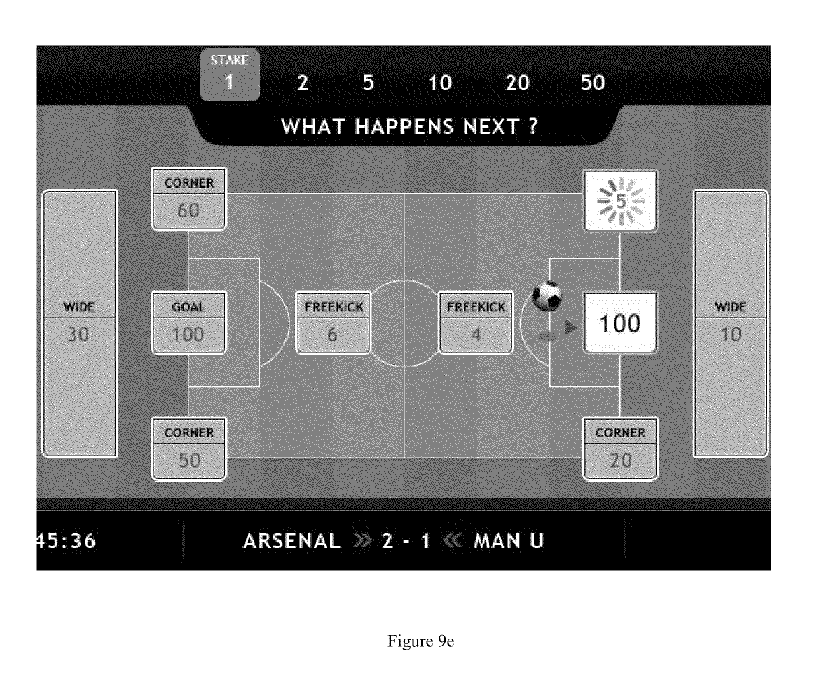

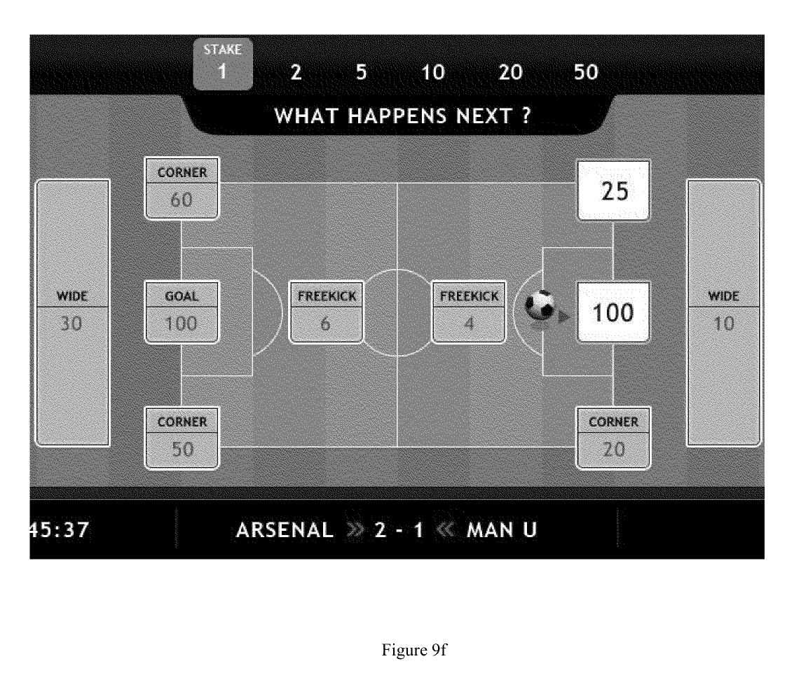

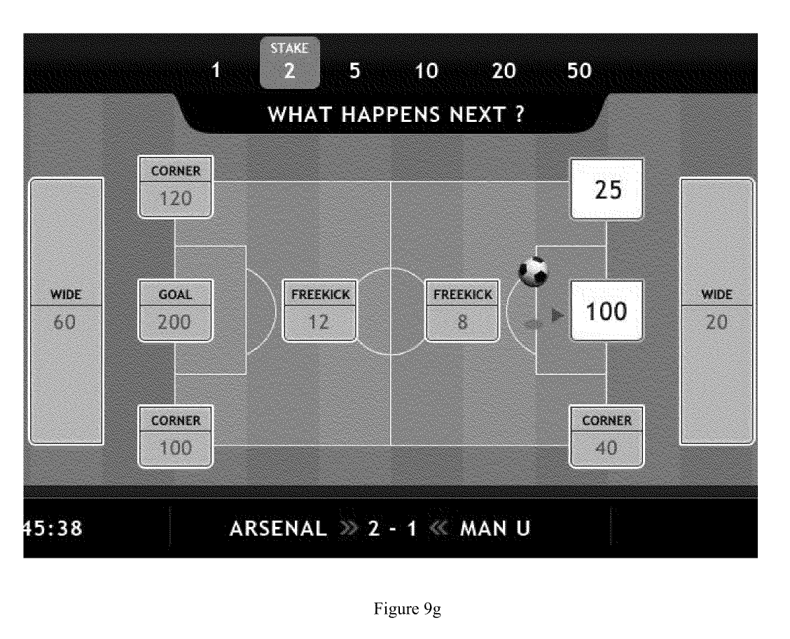

Thus, as shown above, the method of the present invention can be played with any type of sports game, whether team sport or individual sport. Referring to FIG. 9(a-i) there is shown a series of displays showing the changes in the display as the game of International football, or soccer, is played between Manchester Union and Arsenal. In FIG. 9a, the ball is shown as being at midfield and the direction of play is from left to right as indicated by the arrow adjacent to the ball. Thus, the “freekick” section to the left has a lesser payout than the freekick section to the right since the ball is moving from the left half of the pitch to the right half of the pitch. In contrast, the “goal” sections have higher returns on a wager because the probability of a goal being scored from midfield is low, the return would be much higher.

Referring to FIG. 9b, there is shown the play of the game after a minute of play, as evidence by the clock in the lower left hand corner of the display. In real play between Manchester Union and Arsenal, the ball on the field of play has moved to a lower portion of the midfield line. This movement of the ball is reflected in the display of a representation of the field. As a result, changes in the odds for the various sections occurs and the payout for the different sections changes.

Referring to FIG. 9c, there is shown the play of the game after another minute of play. Assuming in real play the ball has now advanced to the lower right hand corner of the field. This then is reflected in the display of the field. In addition, the odds of payout has also changed in the different sections. As can be seen, since the ball is much closer to the section entitled “corner” in the lower right hand corner, i.e. the odds have increased that the ball might be subject to a corner kick from the lower right hand corner, the payout for that section has decreased (from 25 shown in FIGS. 9b to 15 shown in FIG. 9c). In the present invention, an innovative feature is adopted to thwart a player from “gaming” the system. For example, if a player is at the actual sporting event, and also places a wager in one of the sections, a delay, such as seven seconds, is launched for that section (as shown in FIG. 9c in the right hand Goal section). During this period of delay, if the sporting event causes the play to result in any of the sections, then all wagers during a period of delay are voided, and the player's wager is returned to the player. This is because there is usually a period of delay (caused by transmission of signals) between the actual play and the viewing of that at a televised event, and a player at the actual sporting event would have an advantage compared to a player at a remote location who watches the sporting event on a display screen, such as a television.

Referring to FIG. 9d, there is shown the play of the game after another minute of play. The ball has now advanced to the middle of the field in front of the goal, in real play and this change is also reflected in the representation of the field on the display 12. In addition, the odds of payout has also changed in the different sections. The payout for the corners in the right hand side of the field is lower than the payout for the same sections shown in FIG. 9a, when the ball was in midfield, indicating that the odds have increased of a ball being subject to either of the two corner kicks on the right hand side of the field. In this view shown in FIG. 9d, because the player has placed a wager for the Goal section on the right hand side, after the method of the present invention cycles through its seven second delay, as discussed hereinabove, the wager and the payout is recorded in the amount when the wager was placed (as shown in FIG. 9b). The wager recorded is displayed in a different color as shown in FIG. 9d, and does not change and the player cannot place another wager in this section, until the play is settled, by having the play resulting in one of the sections of the field.

Referring to FIG. 9e, there is shown the play of the game after another minute of play. The ball is now in the process of advancing to the goal in the middle of the field. Again, the odds of payout for each section has changed. Similar to the description for FIG. 9c, a seven second delay is started for the section labeled as “Corner” in the upper right hand side.

Referring to FIG. 9f, there is shown the play of the game after another minute of play. The ball has now advanced to the area near the right hand goal. In addition, the odds of payout has also changed for the different sections. However, with regard to the sections for the right hand goal, and the upper right hand corner (i.e. sections with 25 and 100), the payout represents the amount of payout at the time the player placed the wagers, and is now “frozen”.

Referring to FIG. 9g, there is shown the play of the game after another minute of play. The payout has changed for all sections except for the “goal” on the right hand side, and “corner” in the upper right hand side. This is because the player has increased the wager to two units as can be seen at the top of the display. Thus, compared to the payout in the different sections shown in FIG. 9f, all of the sections (except for the “goal” on the right hand side, and “corner” in the upper right hand side) has doubled.

Referring to FIG. 9h, there is shown the play of the game after another minute of play. In this case, the payout has returned to the level shown in FIG. 9f, because the player has lowered the units of wager to one.

Referring to FIG. 9i, there is shown the play of the game after another minute of play. The payout is now frozen because a result has occurred when the real team has scored in the right hand goal. Wagers in all other sections are collected by the “house” and payout is made for the wager, if any, in the section of the right hand goal. Play will resume at midfield. In addition, wagers can be placed in all of the sections.

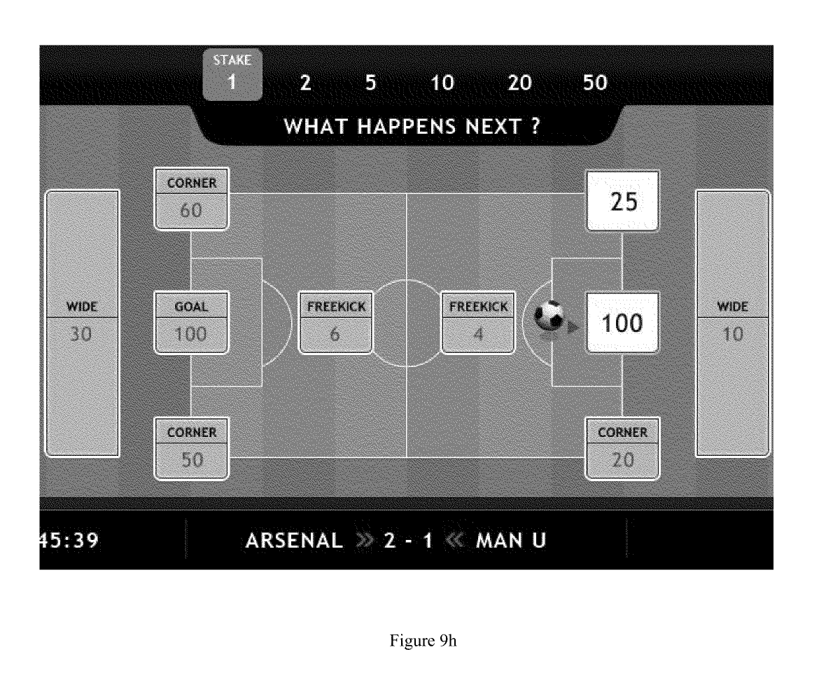

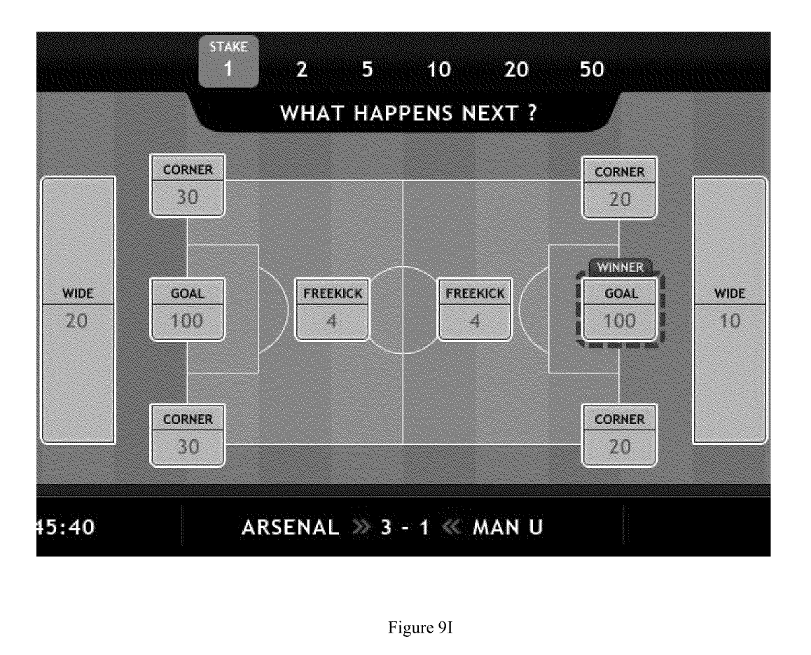

Referring to FIG. 10, there is shown a display on the screen 12 (shown in FIG. 12) of another embodiment of the present invention. In the embodiments shown in FIGS. 1-8, players generally place wagers in different sections of the playing field, against the “house”, in the embodiment shown in FIG. 10, a plurality of players may play against each other, in a social setting. Thus, as will be described in greater detail hereinafter, the method of the present invention may be practiced by execution on a computer either as a standalone program product or a program product executing on a social media platform, such as Facebook, or Google+ etc. In the embodiment shown in FIG. 10, up to six players may all play simultaneously. As shown in FIG. 10, four active players, with names, such as “I. Williams”; “J. Basterman”, “R. O'Dea”; and “S. McCaskill” are shown as “seated” about the playing field, with two empty “seats”, indicated by the icons “+Add Player”. The HOST tab above the player indicates that this “game” is hosted by “I. Williams”. Thus, the other players “J. Basterman”, “R. O'Dea” and “S. McCaskill” are playing by invitation from “I. Williams”. As the “host”, “I. Williams” chooses the décor of the display including the display of the favorite team logos or pennants or flags, and favorite team players. As players play in these rooms, and win, virtual points are awarded to the winners. Further, as each player accumulates sufficient virtual points or tokens, these may be redeemed for pennants, trophies etc. all of which are familiar to one skill in the art regarding social game settings.

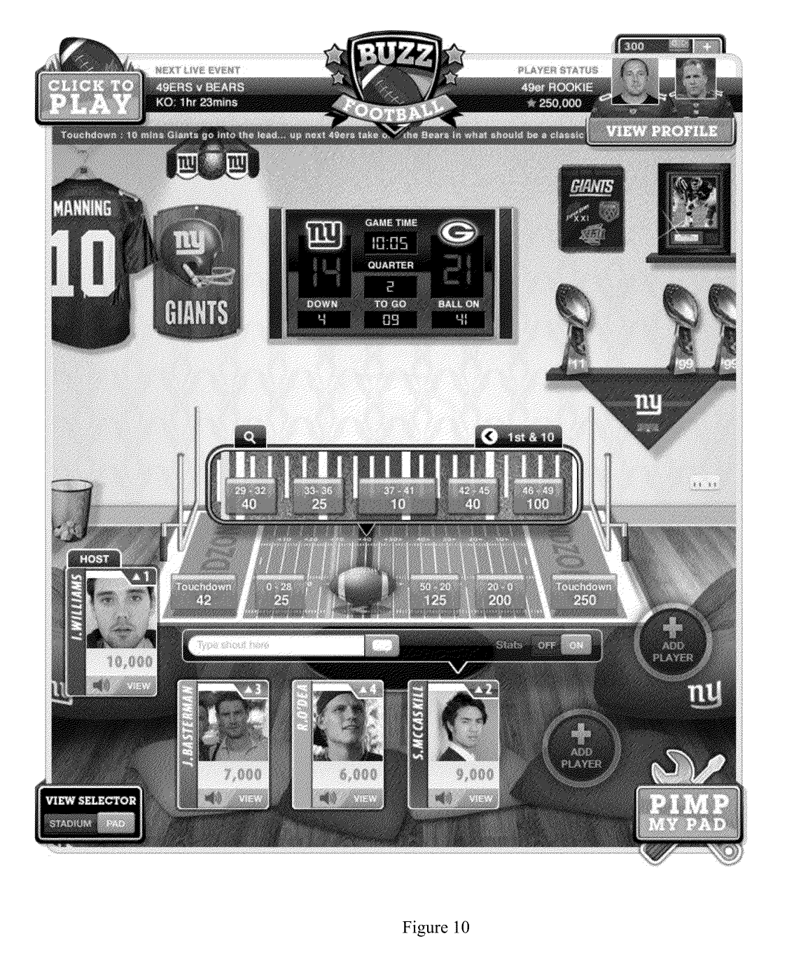

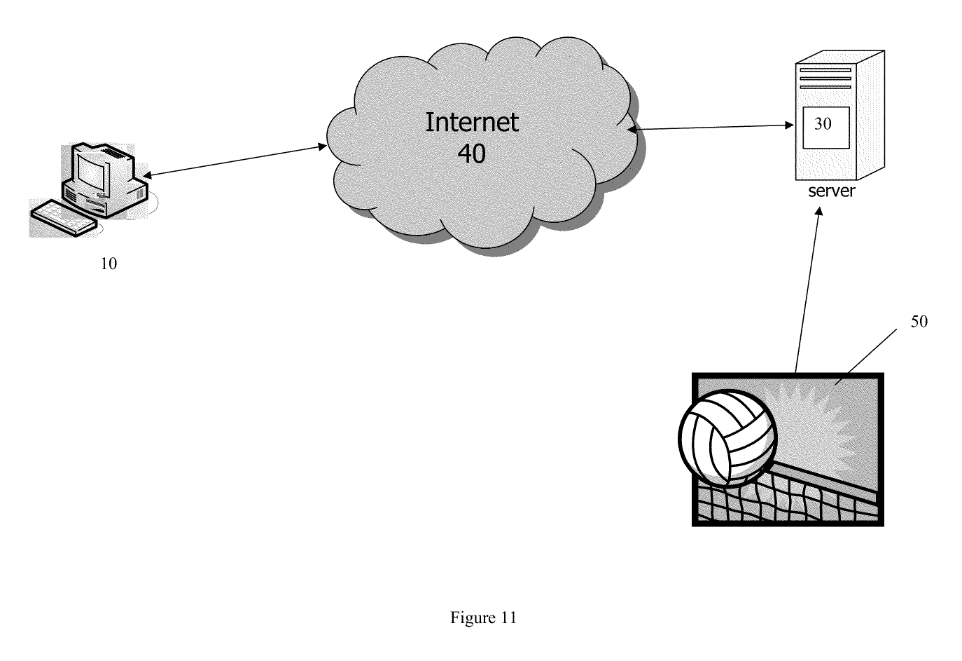

Referring to FIG. 11, there is shown a schematic drawing of an apparatus 10 of the present invention for carrying out the method of the present invention connected to an interconnected network of computers (“Internet”) 40 and through the Internet 40 to a server 30. A playing field 50 upon which the actual sports game is played is also schematically shown. The information from the playing field 50 is supplied to the server 30. This can be done by an observer stationed at the playing field 50 entering relevant information such as, for International football, the location of the ball, into the server 30. The data can be also be from an observer watching a live broadcast of the game; and thus the observer need not be physically at the playing field 50. Once the data for the game at the playing field 50 is entered into the server 30, the relevant data for the display 12 (shown in FIG. 12) of apparatus 10, is sent by the server 30 through the Internet 40 to be displayed on the display device 12 of the apparatus 10. The display device 12 displays the representation of the field upon which the sports game is played at the physical field 50. In addition, as noted hereinabove, the display also shows different sections, with the payout for each section denoted.

The payout for each section is determined based upon the odds of the game being played resulting in the section of the field. Such odds may be determined based upon a number of ways.

However, one exemplar method, though by no means the only method, is as follows. The server 30 may contain a set of historical data of each team's past performance when the ball is in play in the area at that moment of play. Based upon the historical performance of each team, the odds of each team causing the ball to enter into each of the sections in the field can then be calculated. In addition, the “house” may add to or subtract from the odds of play to insure the “house” will always have a statistical win. Of course, with the embodiment of the game of the present invention shown in FIG. 10 for playing on a social platform, there is no “house”.

Thus, as play occurs and changes on the field 50, new data, such as location of the ball or the play, is supplied to the server 30, and new odds are calculated. These odds, which are translated into payouts, are supplied to the apparatus 10 through the Internet 40. In addition, while players may be playing the game on the apparatus 10, they may also be watching on a broadcast medium, such as over-the-air transmission, or cable or satellite, simultaneously with the actual play of the sports game on the physical field 50. In this manner, the enjoyment of watching the actual game is coupled with the anticipation of the “prediction” of the events of the sports game, as evidenced by the wager on the apparatus 10.

Referring to FIG. 12, there is shown a schematic block diagram of one embodiment of the apparatus 10 for carrying out the method of the present invention. The apparatus 10 can be any type of computer, including but not limited to those running Windows (™ of Microsoft Corp) operating system, Mac (™ of Apple Inc.) and those running Linux operating systems, and tablet computers and any of the various mobile handheld devices called smartphones. The apparatus may also be a “smart tv” which is an apparatus that is capable of receiving transmitted signals, i.e. video images of the actual sporting event, as well as having connectivity to the Internet 40 to which the method of the present invention may be played. The video images of the actual sporting event is displayed on the display 12, while the image to display the method of the present invention is shown in an embedded portion of the display 12, or vise versa. The apparatus 10 includes a processor 14, to which a keyboard 18 may be optionally attached. The key board 18 is for input of data into the apparatus 10. Thus, another form of data entry device may include a touch screen for use in lieu of the display 12 and the keyboard 18, with the processor 14 including a controller for controlling the touch screen display 12. The processor 14 is also connected to a communication circuit 16 which can be attached to the Internet 40, through either a direct connection or through a mobile cellular communication network. The processor 14 is also connected to a display 12, which as described heretofore, can display a representation of the field 50 upon which the sports game is played, as well as a plurality of sections where the play can result. Finally, the processor 14 is connected to a non-volatile memory 20 for storing programming code for execution by the processor 14 for implementing the method of the present invention as described heretofore.

From the foregoing it can be seen that there are many advantages of the method and apparatus of the present invention. The invention provides a user with enhanced enjoyment of watching and participating in a real sports game as it is being played in real time.

What is claimed is:

1. A method for participating in playing a sports game comprising:
displaying a representation of a field upon which the sports game is played, with said field having a plurality of sections;
displaying odds of said sports game being played in each of said plurality of sections, as said sports game plays in reality; and
changing the odds in each of said plurality of sections, as said sports game is played.

2. The method of claim 1 wherein said representation of a field is displayed on a computer monitor.

3. The method of claim 2 wherein said computer monitor is connected to a computer which is adapted to receive data from a network of interconnected computers (“Internet”).

4. The method of claim 3 wherein said odds of said sports game being played in each of said plurality of sections is supplied from the Internet.

5. The method of claim 4 wherein the sports game is played by a plurality of sides and wherein the step of changing the odds is based upon historical data of each of the plurality of sides having previously played the sports game.

6. The method of claim 5 wherein said plurality of side is two.

7. The method of claim 1 wherein the sports game is soccer or International style football.

8. The method of claim 1 wherein the sports game is American style football.

9. The method of claim 1 wherein the sports game is tennis.

10. The method of claim 1 wherein the sports game is baseball.

11. The method of claim 1 wherein the sports game is ice hockey.

12. The method of claim 1 wherein the sports game is basketball.

13. The method of claim 1 wherein the sports game is cricket.

14. The method of claim 1 wherein the sports game is rugby.

15. The method of claim 1 wherein the sports game is Australian style football.

16. The method of claim 1 wherein a player places wagers in one or more sections of the field, and wherein payout or settlement is made in the event the sports game proceeds to one of the sections of the field.

17. The method of claim 1 wherein said sports game is played by a plurality of players playing the same sports game against one another.

18. The method of claim 17 wherein each of said plurality of players places wagers on one or more sections of the field and wherein payout or settlement is made in the event the sports game proceeds to one of the sections of the field.

19. An article of manufacture comprising a computer usable medium having a computer readable program code embedded therein, adapted to be executed to implement a method for playing a sports game, said method comprising:
computer program code for displaying a representation of a field upon which the sports game is played, with said field having a plurality of sections;
computer program code for displaying odds of said sports game being played in each of said plurality of sections, as said sports game plays; and
computer program code for dynamically changing the odds in each of said plurality of sections, as said sports game is played.

20. The article of manufacture of claim 19 wherein said computer program code for displaying a representation of a field displays said field on a monitor.

21. The article of manufacture of claim 19 further comprising computer program code for receiving data for odds of said sports game being played in each of said plurality of sections from an interconnected network of computers (“Internet”).

22. A gaming device comprising:
a display device;
a processor;
wireless communication circuits to receive signals from an interconnected network of computers (“Internet”); and
a non-volatile memory for storing computer program code for execution by the processor causing a representation of a field upon which the sports game is played to be displayed, with said field having a plurality of sections;
causing the odds of said sports game being played in each of said plurality of sections, as said sports game plays to be displayed; and
causing the odds in each of said plurality of sections, as said sports game is played to dynamically change.
